(19) United States
(12) Patent Application Publication
(10) Pub. No.: US 2012/0036526 A1
(43) Pub. Date: Feb. 9, 2012

(54) ELECTRONIC DEVICE AND METHOD FOR EMBEDDING PRODUCT INFORMATION IN TV PROGRAMS WITH PRODUCT PLACEMENTS

(75) Inventors: CHUNG-I LEE, Tu-Cheng (TW); CHIEN-FA YEH, Tu-Cheng (TW); SHAN-CHUAN JENG, Tu-Cheng (TW); CHENG-FENG TSAI, Tu-Cheng (TW); TSUNG-HSIN YEN, Tu-Cheng (TW); YU-FENG CHIEN, Tu-Cheng (TW); HO-I SUN, Tu-Cheng (TW)

(73) Assignee: HON HAI PRECISION INDUSTRY CO., LTD., Tu-Cheng (TW)

(21) Appl. No.: 13/092,153

(22) Filed: Apr. 22, 2011

(30) Foreign Application Priority Data
Aug. 9, 2010 (TW) 99126404

(51) Int. Cl. H04N 7/10

(52) U.S. Cl. 725/32

(57) ABSTRACT

A method embeds product information in TV programs with product placements using an electronic device. The electronic device encloses presented products of the TV program in a graphic box, and defines advertising information related to the presented products. During the TV program broadcasts, the electronic device receives a selection operation on a product displayed on a display device, exports the advertising information of the selected product, and embeds the advertising information of the selected product to the TV program. The advertising information is displayed on the display device concurrently with the TV program.

### BACKGROUND

1. Technical Field

Embodiments of the present disclosure generally relate to advertisement displaying devices and methods, particularly to an electronic device and method for embedding product information in TV programs with product placements.

2. Description of Related Art

Product placement is increasingly becoming a popular form of advertising in today's media environment, especially with the growing use of digital recording devices such as TIVO and DVR that allow viewers to skip commercials. While there are numerous advantages to this marketing strategy, one major disadvantage is that the viewers have no concrete information on what the product is or even where to purchase it. This lack of information contributes the lack of sales growth often associated with effective advertising.

### BRIEF DESCRIPTION OF THE DRAWINGS

FIG. 1 is a block diagram of one embodiment of an electronic device including an embedding unit.

FIG. 2 is a block diagram of one embodiment of function modules of the embedding unit of FIG. 1.

FIG. 3 is a flowchart illustrating one embodiment of a method for embedding product information in TV programs with product placements.

### DETAILED DESCRIPTION

In general, the data “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

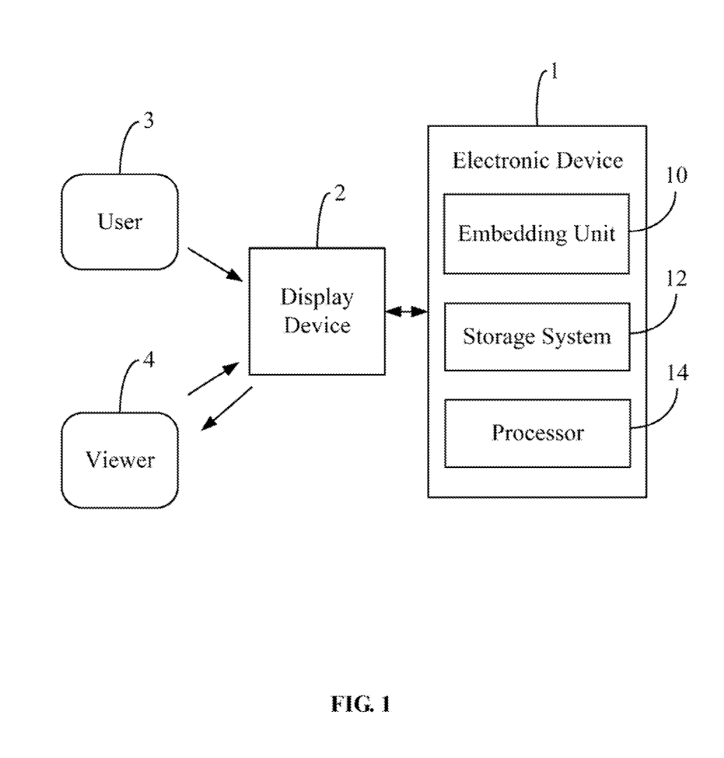

FIG. 1 is a block diagram of one embodiment of an electronic device 1 including an embedding unit 10. In the embodiment, functions of the embedding unit 10 are implemented by the electronic device 1; the embedding unit 10 can embed advertising information of products presented in a TV program, and display the advertising information on a display device 2 that is electronically connected to the electronic device 1 via a wired or wireless connection during the TV program broadcasts. In one embodiment, the products may be cars, watches, or clothes. The advertising information of the products may include text, audio, an advertisement file, a Web advertisement, and/or a shopping website. The TV program may be a movie, a TV series, or any other entertainment show.

In one embodiment, the electronic device 1 may be a computer, a TV, a portable electronic device, or any other electronic device that includes a storage system 12 and at least one processor 14.

The embedding unit 10 is configured to receive advertising information of products that may be presented on the TV program from a user 3. When a viewer 4 selects a product displayed on the TV program, the embedding unit 10 can export the advertising information of the selected product to the TV program, and displays the advertising information concurrently with the TV program.

The display device 2 is used for receiving a selection operation of the product from the viewer 4, and displaying the advertising information of the selected product concurrently with the TV program. In the embodiment, the display device 2 is a touch-sensitive display or a 3D display, and can receive an input operation of the viewer 4 using a finger or a stylus pen. For example, if the electronic device 1 is a TV, the viewer 4 can use a remote control to operate (i.e., select a product) the electronic device 1.

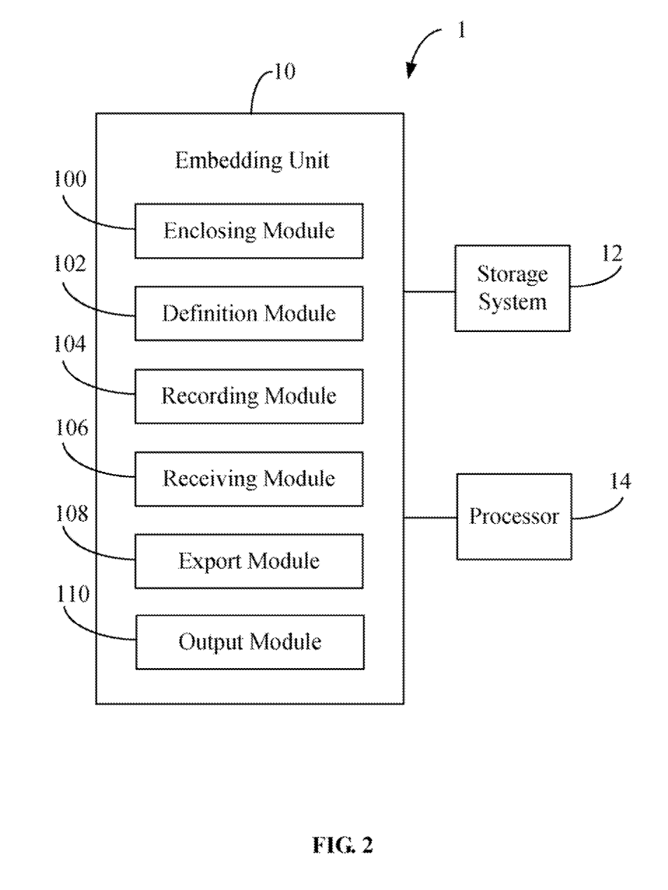

FIG. 2 is a block diagram of one embodiment of function modules of the embedding unit 10 of FIG. 1. In one embodiment, the embedding unit 10 includes an enclosing module 100, a definition module 102, a recording module 104, a receiving module 106, an export module 108, and an output module 110. Each of the modules 100-110 may be a software program including one or more computerized instructions that are stored in the storage system 12 and executed by the processor 14.

In one embodiment, the storage system 12 may be a magnetic or an optical storage system, such as a hard disk drive, an optical drive, or a tape drive.

Before the display device 2 broadcasts a TV program, the enclosing module 100 encloses presented products of the TV program in a graphic box. The graphic box can be a rectangle, a circle, lines, or a box drawn by the user 3. In the embodiment, the definition module 102 defines a size of the graphic box according to a displayed size of the product on the display device 2.

The definition module 102 further defines the advertising information of the products. As mentioned above, the advertising information comprises characters, audio, an advertisement file, a Web advertisement, and/or a shopping website.

The recording module 104 records the advertising information. In one embodiment, the advertising information of each product can be recorded in an image file that is compatible with the TV program. The image file may be in format of a MPEG-2, MPEG-4, or an AVC format.

When the display device 2 displays the TV program, the receiving module 106 receives a selection operation of a product from the viewer 4. For example, if the display device 2 is a touch-sensitive display, the viewer 4 may use a finger to select the product presented on the TV program, and then the receiving module 106 receives the selection operation.

The export module 108 exports the advertising information of the selected product from the image file, and embeds the advertising information of the selected product to the TV program.

The output module 110 displays the advertising information of the selected product on the display device 2 so the viewer 4 can browse the advertising information while the display device 2 broadcasts the TV program.

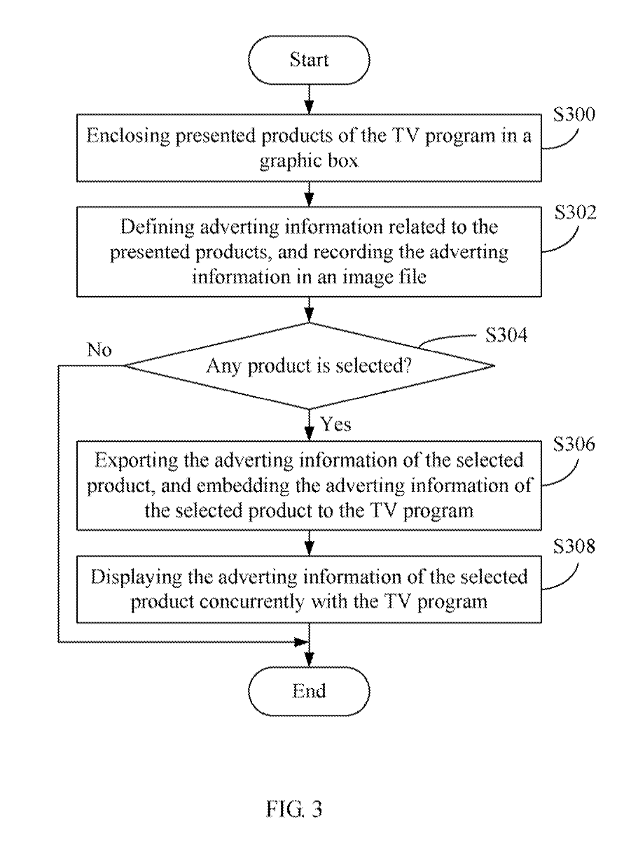

FIG. 3 is a flowchart illustrating one embodiment of a method for embedding product information in TV programs with product placements. Depending on the embodiment, additional blocks may be added, others removed, and the ordering of the blocks may be changed.

In block S300, the enclosing module 100 encloses presented products of the TV program in a graphic box. In the embodiment, the TV program may be a movie, a TV series, or any other entertainment shown. The graphic box can be a rectangle, a circle, lines, or a box drawn by the user 3. In the embodiment, a size of the graphic box can be defined according to a displayed size of the product on the display device 2.

In block S302, the definition module 102 defines advertising information related to each product, and the recording module 104 records the advertising information in an image file that is compatible with the TV program. In the embodiment, the advertising information comprises texts, audio, an advertisement file, a Web advertisement, and/or a shopping website. The image file may be in format of a MPEG-2, MPEG-4, or an AVC format.

When the display device 2 displays the TV program, in block S304, the receiving module 106 determines whether any product presented on the TV program has been selected by the viewer 4. In one example, the viewer 4 may touch the display device 2 with a finger to select the product. If any product has been selected, block S306 is implemented. If no product is selected, the flow ends.

In block S306, the export module 108 exports the advertising information of the selected product from the image file, and embeds the advertising information of the selected product to the TV program.

In block S308, the output module 110 displays the advertising information of the selected product on the display device 2 concurrently with the TV program, so that the viewer 4 can browse the advertising information of the selected product while the display device 2 broadcasts the TV program.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for embedding product information in TV programs with product placements using an electronic device, the method comprising:
enclosing presented products of the TV program in a graphic box;
defining advertising information related to the products;
selecting a product from the presented products displayed on a display device electronically connected to the electronic device during the TV program broadcasts;
exporting the advertising information of the selected product, and embedding the advertising information of the selected product to the TV program; and
displaying the advertising information of the selected product on the display device concurrently with the TV program.

2. The method as described in claim 1, further comprising:
defining a size of the graphic box according to a displayed size of the corresponding product on the display device.

3. The method as described in claim 1, further comprising:
recording the advertising information of the product in an image file that is compatible with the TV program.

4. The method as described in claim 3, wherein the image file is in format of a MPEG-2, MPEG-4, or an AVC format.

5. The method as described in claim 3, wherein the TV program is a movie, a TV series, or an entertainment show.

6. The method as described in claim 1, wherein the graphic box is a rectangle, a circle, lines, or a box that is drawn by a user.

7. The method as described in claim 1, wherein the advertising information comprises characters, audio, an advertisement file, a Web advertisement, and/or a shopping website.

8. An electronic device, comprising:
at least one processor;
a storage system; and
one or more modules that are stored in the storage system and are executed by the at least one processor, the one or more modules comprising instructions:
to enclose presented products of the TV program in a graphic box;
to define advertising information related to the products;
to select a product from the presented products displayed on a display device electronically connected to the electronic device during the TV program broadcasts;
to export the advertising information of the selected product, and to embed the advertising information of the selected product to the TV program; and
to display the advertising information of the selected product on the display device concurrently with the TV program.

9. The electronic device as described in claim 8, wherein the instructions further define a size of the graphic box according to a displayed size of the corresponding product on the display device.

10. The electronic device as described in claim 8, wherein the advertising information related to the products are recorded in an image file that is compatible with the TV program.

11. The electronic device as described in claim 10, wherein the image file is in format of a MPEG-2, MPEG-4, or an AVC format.

12. The electronic device as described in claim 10, wherein the TV program is a movie, a TV series, or an entertainment shown.

13. The electronic device as described in claim 8, wherein the graphic box is a rectangle, a circle, lines, or a box that is drawn by a user.

14. The electronic device as described in claim 8, wherein the advertising information comprises characters, audio, an advertisement file, a Web advertisement, and/or a shopping website.

15. A non-transitory storage medium having stored thereon instructions that, when executed by a processor of an electronic device, causes the processor to perform a method for embedding product information in TV programs with product placements, the method comprising:
enclosing presented products of the TV program in a graphic box;
defining advertising information related to the products;
selecting a product from the presented products displayed on a display device electronically connected to the electronic device during the TV program broadcasts;
exporting the advertising information of the selected product, and embedding the advertising information of the selected product to the TV program; and
displaying the advertising information of the selected product on the display device concurrently with the TV program.

16. The non-transitory storage medium as described in claim 15, wherein the method further comprises:
defining a size of the graphic box according to a displayed size of the corresponding product on the display device.

17. The non-transitory storage medium as described in claim 15, wherein the method further comprises:
recording the advertising information of the product in an image file that is compatible with the TV program.

18. The non-transitory storage medium as described in claim 17, wherein the image file is in format of a MPEG-2, MPEG-4, or an AVC format.

19. The non-transitory storage medium as described in claim 17, wherein the TV program is a movie, a TV series, or an entertainment shown.

20. The non-transitory storage medium as described in claim 15, wherein the advertising information comprises characters, audio, an advertisement file, a Web advertisement, and/or a shopping website.
